(19) United States
(12) Patent Application Publication
(10) Pub. No.: US 2015/0049731 A1
(43) Pub. Date: Feb. 19, 2015

(54) Method for Coding OFDMA Data without Pilot Symbols

(71) Applicant: Mitsubishi Electric Research Laboratories, Inc., Cambridge, MA (US)

(72) Inventors: Chunjie Duan, Brookline, MA (US); Philip Orlik, Cambridge, MA (US)

(73) Assignee: Mitsubishi Electric Research Laboratories, Inc., Cambridge, MA (US)

(21) Appl. No.: 13/968,453

(22) Filed: Aug. 16, 2013

(51) Int. Cl. H04B 1/69

(52) U.S. Cl. CPC H04B 1/69
USPC 370/330

(57) ABSTRACT

A wireless network includes a set of nodes. Each node includes a transmitter and a receiver. A block of data bits is converted to a block of data symbols. The block of data symbols is partitioning timewise into groups of data symbols. A set of subcarriers is assigned to each group of data symbols, and each group of data symbols is spread to a chip sequence using a coding block of spreading sequences, wherein the spreading sequences are based on types of the groups of data symbols. Then, after the spreading, the chips are transmitted as orthogonal frequency-division multiplexing (OFDM) data symbols on the assigned subcarriers.

### FIELD OF INVENTION

The invention relates generally to digital wireless communications, in particular, to coding data reliably in a wireless network without using pilot symbols.

### BACKGROUND OF THE INVENTION

Wireless communications have a wide range of applications that are significantly different from one another. in machine to machine (M2M) networks, a significant challenge is high reliability and low latency. Another distinctive feature of M2M networks is that they generally transmit a very small amount of data.

Many M2M networks assume a point to multi-point network, i.e., a star topology, where multiple nodes communicate with a central node using a shared channel with a guaranteed latency. Therefore, efficient multiple-access is necessary. Time division multiple access (TDMA) is one commonly used method. In a TDMA network, nodes are assigned dedicated time slots and data from the nodes are transmitted sequentially. Frequency division multiple access (FDMA) can also be used. In a FDMA network, the nodes transmit data on assigned carriers.

As shown in FIG. 1, orthogonal frequency-division multiple access (OFDMA) enables multiple nodes to transmit concurrently. The transmission bandwidth 105 is partitioned into a set of N non-overlapping carriers 103. In an OFDMA network, each node is assigned one or more subcarriers 104, and each node only transmit on the assigned subcarriers. The signals received at the receiver include signals from all the transmitting nodes. During the transmission, the subcarrier assignment remains the same. Therefore, the network is vulnerable to frequency selective fading and a low signal to noise ratio (SNR).

As shown in FIG. 2, to facilitate coherent reception, known pilot symbols (PS) 107 are transmitted before data symbols (Dₘ) 102. The pilot symbols are used to estimate the channel response. In the conventional OFDMA network, the pilot symbols PS are transmitted on the same subcarriers 103 as the data symbols Dₘ.

Pilot symbols do not carry data and therefore constitute overhead. The transmission of pilot symbols reduces the overall bandwidth efficiency. This is significant in the case of M2M communications, because nodes typically transmit very small size data packets and M2M communication becomes extremely inefficient when a large number of pilot: symbols are transmitted.

U.S. 20100246642 describes an OFDM-code division multiple access (CDMA) network that combines coding domain spreading and. multiplexing. In that OFDM-CDMA scheme, the spreading is performed in the frequency domain i.e., the data are first converted to the frequency domain signals (OFDM signals) and then spread using orthogonal sequences. Additionally, the reception of the data is coherent, and as a result, the receiver must equalize the channel before dispreading can be performed. Pilots can be used to perform channel estimation and equalization.

U.S. Pat. Nos. 7,471,932 and 8,023,905 describe a method that combines CDMA signals and OFDM signals. Two streams are processed independently and then overlaid on each other.

U.S. 20050163082 describes a method for transmitting signals to multiple receivers. Each signal is first spread using a unique spreading sequence unique and multiplexed. The receiver performs a fast Fourier transform (FFT) on the received signal, and compensates for the propagation channel response. The compensated signal is then de-spread to recover the transmitted signals.

### SUMMARY OF INVENTION

The embodiments of the invention provide a method for coding data communicated in a wireless network of transceivers (nodes). The coding uses orthogonal frequency-division multiple access (OFDM A) and achieves high frequency diversity without transmitting pilot symbols or pilot tones as in the prior art. Each transmitter only transmits data symbols. The data symbols are transmitted on assigned set of subcarriers. Each transmitter is assigned a set of different subcarriers for different groups of data symbols. The data to be transmitted are spread over a group of symbols using a set of orthogonal spreading Sequences. Each transmission includes one or more groups of symbols.

The receiver transforms received time domain signals to frequency domain subcarriers. The receiver de-spread the subcarriers within the groups with all possible orthogonal spreading sequences and then decodes the data using decoders, such as a maximum likelihood (ML) decoder. The receiver can also estimate the channel response using decoded data symbols.

The main differences between the prior art coding and the invention include the following.

In prior art, a block of spreading sequences are preassigned to each node. Data from multiple nodes are spread with a node the specific assigned spreading code before multiplexed to subcarriers. Each spread chip sequence is distributed over multiple subcarriers.

In the embodiments of the invention, the encoding by the transmitter spreads the data using the same set of spreading sequences. However, now the output of the spreading is dependent on the current data block being transmitted, and not some preassigned spreading code as in the prior art. In other words, there is a distinct spreading sequence for each type of data symbol. The data in the invention are spread in time domain, and not in the frequency domain as in the prior art. Each subcarrier is only assigned to one node at a given time by the invention, i.e., the subcarriers are not shared by nodes as in the prior art.

The prior art generally used pilot symbols. The invented coding does not use pilot symbols or pilot tones, and different sets of subcarriers are allocated to a single node to enable maximum frequency diversity. Therefore, in the embodiments of the invention, the receiver decodes the received signal incoherently, without knowledge about channel. Each symbol group is decoded independently. The embodiments can also use phase and amplitude scrambling to reduce the peak to average power ratio (PAPR).

### BRIEF DESCRIPTION OF THE DRAWINGS

FIGS. 1 and 2 are block diagrams of coding in conventional OFDMA-based wireless communicating network;

FIGS. 3 and 4 are block diagrams of coding OFDMA data according to embodiments of the invention;

FIG. 5 is a block diagram of transmitter according to embodiments of the invention; and

FIG. 6 is a block diagram of a receiver according to embodiments of the invention.

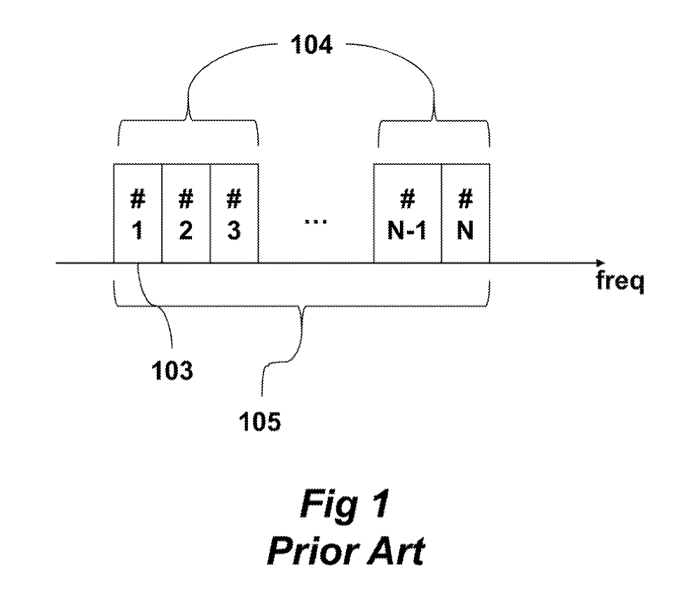

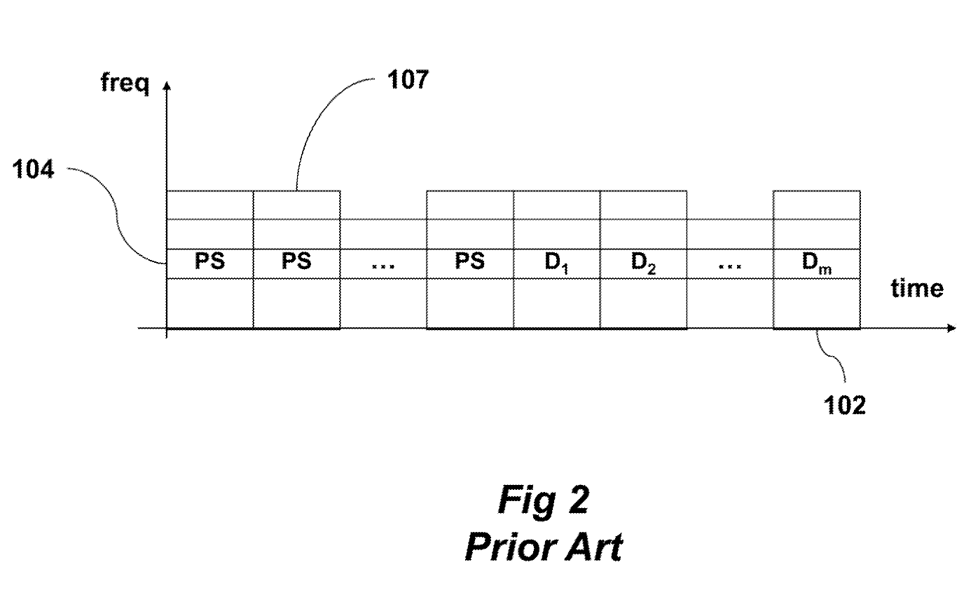

### DETAILED DESCRIPTION OF THE PREFERRED EMBODIMENTS

OFDMA Coding

The embodiments of the invention provide a method for coding data communicated in a wireless network of transceivers (nodes). The network can be a machine to machine (M2M) network.

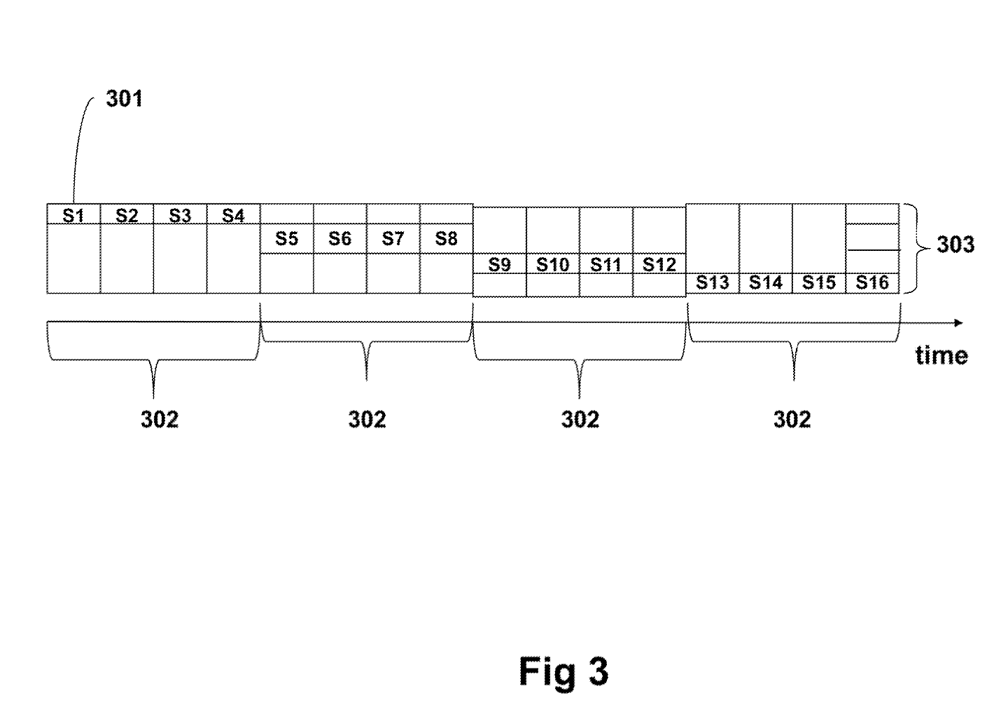

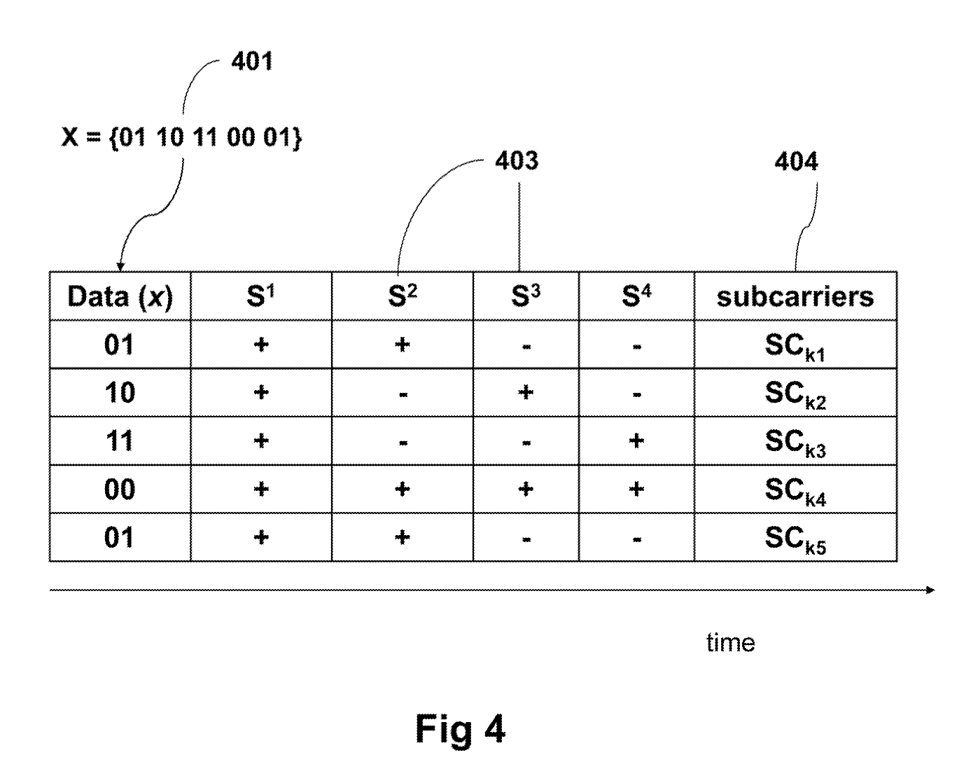

FIGS. 3 and 4 show a coding of orthogonal frequency-division multiple access (OFDMA) data symbols according to embodiments of our invention. OFDMA is a multi-user version of orthogonal frequency-division multiplexing (OFDM). In OFDMA, multiple access is achieved by assigning subsets of subcarriers to individual nodes as described below.

In this example, a transmitted packet includes a set of (16) data OFDM symbols (S1, . . . , S16) 301. The data symbols are partitioned timewise into, e.g., four groups 302 of four OFDM symbols in each group. It should be rioted that the groups do not need to be symmetric.

A node is assigned a set of (four) subcarriers 303 for each group. The set can include one or more subcarriers. The assigning of the subcarriers for a particular group can change over time. The assigned subcarriers of a given node can be distributed evenly over the entire useable bandwidth to provide frequency diversity.

For a group of M=2^{m} symbols, we partition the data into m-bit blocks. Each set of subcarrier of a. group transmits m-bits. If the node is assigned k subcarriers, the node transmits a block of data of k×m bits in each group.

Encoding

The spreading converts an m-bit data block into a 2 symbol sequence. The m-symbols of the sequence are used to modulate the subcarrier for the 2^{m} symbols, The spreading can he according to any sets of orthogonal or quasi-orthogonal sequences, such as a Walsh-Hadamard sequence, orthogonal Fourier sequences, or a wavelet sequence.

As shown in FIG. 4 for example, if m=2, each group has four OFDM symbols, and the transmission will span four groups, or 16 OFDM symbols. We can use the Walsh-Hadamard matrix given in Table 1 for spreading. The spreading function g=D(x) is a linear mapping of information bits x. For example, the data symbol 00 is mapped to a four chip sequence [1+1+1+1] or [++++]. There is one specific spreading sequence for each type of symbol.

The symbol 10 is mapped to [+1−1+1−1], where 1 corresponds to + and − corresponds −1 in the table. The chip sequences g, after spreading, is then used to modulate the corresponding assigned subcarriers for the group of symbols to produce the OFDM data symbols for transmission.

TABLE 1
Hadamard-Walsh Spreading Sequences of length 4

| Data | Spread sequence |
|---|---|
| (x) | D(x) |
| 00 | +1 +1 +1 +1 |
| 01 | +1 +1 −1 −1 |
| 10 | +1 −1 +1 −1 |
| 11 | +1 −1 −1 +1 |

Modulation Block

FIG. 4 shows a coding the m-bit data block X ={01 10 11 00 01} 401. The bits are partitioned into log₂(4)=2 bit groups 401. The bits are coded over sets of subcarriers (SCₖ₁, . . . , SCₖ₅) 404 and groups (S¹, . . . , S⁴) 403. Every bit group is spread to a four symbol sequence as defined in Table 1. Each sequence corresponds to one of the five sets of subcarriers and is transmitted on the corresponding subcarrier set. For example, symbol S² is modulated with a vector [+1−1−1+1+1]. Each type of symbol uses a different spreading sequence based. on the symbol, e.g., FIG. 4 shows four types of symbols and four distinct spreading sequences.

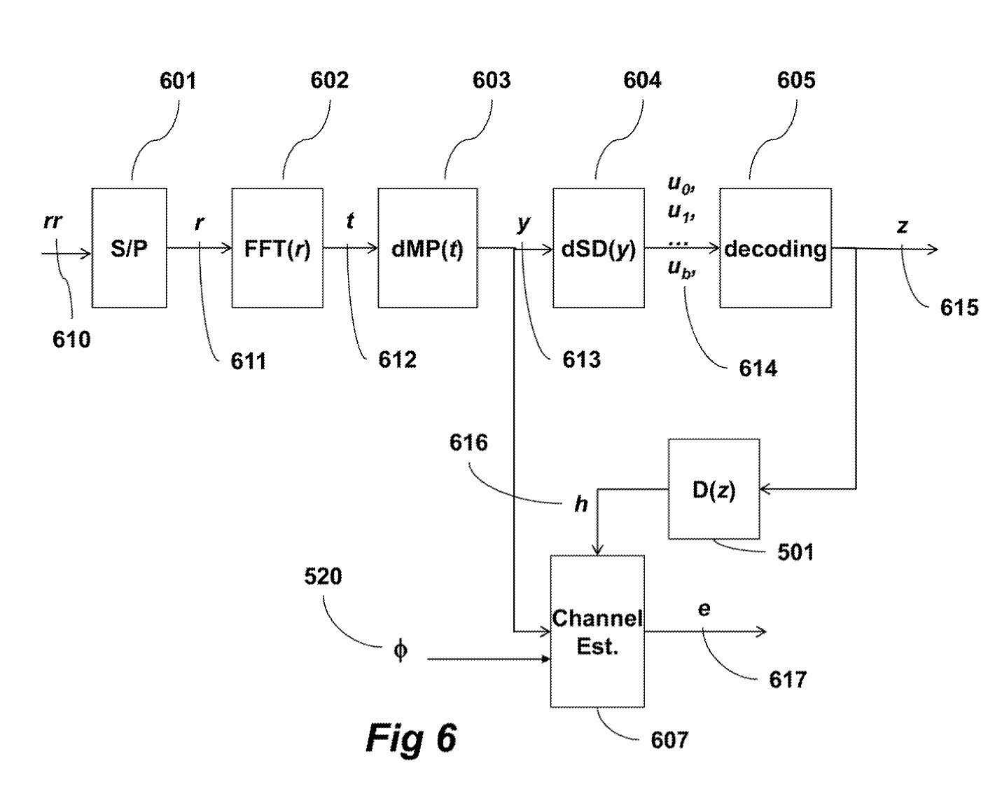

The spreading can affect the peak to average power ratio (PA PR). For example, the modulation vector for S¹ is [+1 +1 +1 +1+1] results in a very high PAPR. The transmitter can modify the sequence for each subcarrier with an arbitrary phase rotation and/or amplitude multiplication scrambling vector in order to reduce the PAPR as described below with reference to FIG. 6.

The signal is transformed into a time domain sequence p using an inverse Fourier Transform (IFFT). The time domain sequence can be processed to add cyclic prefix and converted to an analog signal, and then into a radio frequency signal (RF) before transmission.

Transmitter

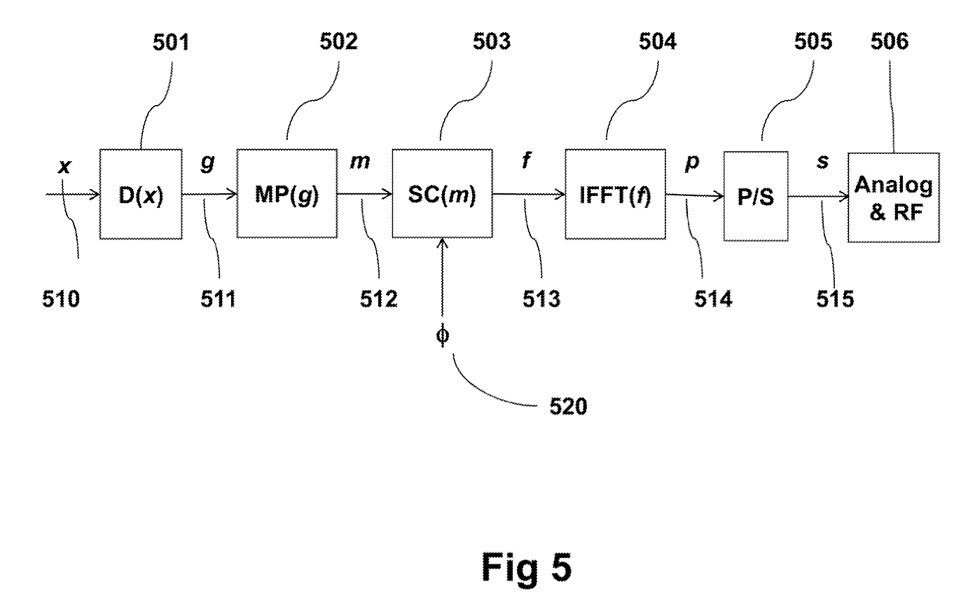

FIG. 5 shows a transmitter according to embodiments of the invention. The transmitter performs the encoding as describe above. An input signal, e.g., a in-bit data block X 510 is spread D(x) 501 to produce g 511, which is mapped M(g) 502 to produce a mapped signal in 512. The mapping is according to the assigned subcarriers. If necessary, the mapped signal is scrambled S(m) 503 with a scrambling sequence 520 to produce the signal f 513, to which the IFFT(f) is applied 504 to produce a time domain signal p 514 which is converted 505 from parallel to serial (P/S) s 515, and then to the analog radio frequency (RF) domain 506 before transmission by antenna 507. The phase and amplitude scrambling φ 520 can optionally be applied to reduce the PAPR.

Receiver

FIG. 6 shows a receiver according to embodiments of the invention. The receiver performs maximum likelihood (ML) decoding. The decoding is can be incoherent, i.e., without known a state of the channel, because no pilot symbols are transmitted to estimate the channel.

The RF signal at the antenna 600 is converted to a baseband and discretized to discrete signal rr 610. The signal is processed by the S/P block 601 to line up the FFT window and remove the cyclic prefix. The data r 611 is transformed 602 to a frequency domain signal t 612 by a Fourier transformation FFT(r) The signal t 612 is demapped dM(t) 603 to y. The demapped signal y 613 is despread dS(y) 604 with all possible chip sequences e.g., for 4 chip sequences. Table I lists all 4 entries, as described above, to generate the despread signals u₀, u₁, . . . u_{b} 614. The decoding function 605 compares the despread signals and outputs the data bits z 615 with the maximum likelihoods.

Decoding

The dispreading takes the demapped signal of each group (y₁, y₂, . . . , y₂^{M}) and generated a listed of despread signals as

$${u}_{i} = {\sum }_{j = l}^{{2}^{m}} ‖ {y}_{j} {d}^{*} i , j ‖ ,$$

where d*ᵢⱼ is a complex conjugate of the j^{th} element of the i^{th} spreading sequence. For example, if m=2, according to Table 1, then we have

u₀₀=abs(r₁+r₂+r₃+r₄),

u₀₁=abs(r₁+r₂−r₃−r₄),

u₁₀=abs(r₁−r₂+r₃−r₄), and

u₁₁=abs(r₁−r₂−r₃+r₄).

The decoding determines the candidate of u_{z}(y) with the maximum likelihoods, i.e., the candidate with the maximum value.

Subcarrier Assignment

For frequency diversity, the data of each node is assigned (mapped) 502 to different subcarrier in each symbol group in the frequency domain. It is not required that all subcarriers in the subcarriers in the set are contiguous.

The assignment of the set of subcarriers can be arbitrary. E.g., the same set can be used for all groups. However, to maximize the frequency diversity, the carriers in the set are evenly distributed over the entire transmission bandwidth for the duration of the transmission. As a simplified example, if the total number of subcarrier is 128 and the number of groups is four, then each set of subcarriers has 32 subcarriers. Le., if the subcarriers are indexed as [1, . . . , 128] according to frequency, then transmission is on the set of subcarriers [1, 2, 3, 4, 5] during the 1^{st} group of symbols, the set [33, 34, 35, 36, 37] for the 2^{nd} group, the set [65, 66, 67, 68, 69] for the 3^{rd} group and the set [96, 97, 98, 99, 100] for the 4^{th} group of symbols, and so forth. The receiver maps the subcarriers the same way as the transmitter.

Channel Estimation

FIG. 6 also shows the receiver that performs the channel estimation 607 using the decoded data. After the data z 615 are decoded, the receiver can regenerate the estimated transmitted spreading sequence h 616 by feeding the decoded data z through the descrambler spreader 619. By comparing the received signal y 613 to the regenerated symbol sequence, the receiver can estimate the channel response of the corresponding subcarriers e 617. If the phase and amplitude scrambling φ 520 is used by the transmitter, then the receiver can also remove the scrambling.

Although the encoding and decoding are described as method steps it is understood that they can be performed by discrete circuits in the transmitter and the receiver. For example, the assigning, scrambling, transforming and converting are performed by interconnected hardware modules or other means that implement the steps.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

1. A method for coding in a wireless network including a set of nodes, wherein each node includes a transmitter and a receiver, comprising:
converting a block of data bits to a block of data symbols, wherein the data symbols do not include any pilot symbols;
partitioning, timewise, the block of data symbols into groups of data symbols;
assigning a set of subcarriers to each group of data symbols after the Partitioning;
spreading each group of data symbols to a chip sequence using a coding block of spreading sequences, wherein the spreading sequences are based on types of data bits in the data symbols in the groups; and
transmitting, after the spreading, the chips as orthogonal frequency-division multiplexing (OFDM) data symbols on the assigned subcarriers.

2. The method of claim 1, wherein the network uses orthogonal frequency-division multiple access (OFDMA)

3. The method of claim 1, wherein the spreading sequences are Walsh-Hadamard sequences.

4. The method of claim 1, wherein the spreading sequences are orthogonal Fourier sequences.

5. The method of claim 1, wherein the assigning changes the set of subcarriers for a particular group over time.

6. The method of claim 1, wherein the subcarriers are distributed evenly over an entire useable bandwidth.

7. The method of claim 1, wherein there m data bits and k subcarriers so that k×m bits are transmitted for each group.

8. The method of claim 1, wherein the spreading is in a time domain.

9. The method of claim 1, wherein each subcarrier is only assigned to one of the nodes at a given time.

10. The method of claim 1, further comprising:
scrambling the symbols in phase and amplitude.

11. The method of claim 1, wherein the network is a machine to machine network.

12. The method of claim 1, further comprising:
decoding the orthogonal frequency-division multiplexing (OFDM) signals symbols incoherently.

13. The method of claim 1, further comprising:
decoding the orthogonal frequency-division multiplexing (OFDM) signals symbols using a maximum likelihood decoder.

15. (canceled)

14. The method of claim 1, further comprising:
despreading received OFDM data symbols corresponding to the transmitted OFDM data symbols using all spreading sequence in the coding block to determine a despreaded output that has a maximum likelihood of being the group of data symbols.

15. The method of claim 1, wherein the assigning of the subcarriers is arbitrary.

16. (canceled)

17. The method of claim 1, further comprising:
estimating a channel state from the transmitted OFDM data symbols.
